(19) United States
(12) Patent Application Publication
(10) Pub. No.: US 2023/0116566 A1
(43) Pub. Date: Apr. 13, 2023

(54) METHOD AND APPARATUS FOR MANAGING APPLICATION

(71) Applicant: SAMSUNG SDS CO., LTD., Seoul (KR)

(72) Inventors: Dong Ho KIM, Seoul (KR); Hong Chul LEE, Seoul (KR); Been JANG, Seoul (KR)

(73) Assignee: SAMSUNG SDS CO., LTD., Seoul (KR)

(21) Appl. No.: 17/964,576

(22) Filed: Oct. 12, 2022

(30) Foreign Application Priority Data
Oct. 12, 2021 (KR) 10-2021-0134879

(51) Int. Cl. H04W 12/06; H04L 9/32; G06F 21/44; H04L 9/08; H04L 9/14; H04W 12/30; H04W 12/03

(52) U.S. Cl. CPC H04W 12/06; H04L 9/3236; G06F 21/44; H04L 9/0825; H04L 9/14; H04L 9/0863; H04W 12/30; H04W 12/03; H04L 2209/80

(57) ABSTRACT

A method for managing an application in a short-range communication device according to some embodiments of the present disclosure includes receiving application installation request information from an administrator of the short-range communication device, generating authentication information for installing the application by using the received application installation request information, requesting a first server to verify the authentication information, downloading application installation data based on a verification of the authentication information, and installing the application in an application platform region of the short-range communication device using the application installation data, and installing an applet for interworking with the application in a secure element of the short-range communication device.

This application claims the benefit of Korean Patent Application No. 10-2021-0134879, filed on Oct. 12, 2021, in the Korean Intellectual Property Office, the disclosure of which is incorporated herein by reference in its entirety.

### BACKGROUND

### 1. Field

The present disclosure relates to a method and apparatus for managing an application of a short-range communication device. More particularly, it relates to an application management method and apparatus for managing application installation, deletion, and the like of a short-range communication device.

### 2. Description of the Related Art

Recently, Ultra-Wide Band (UWB) communication technology has begun to be used for accurate distance measurement and data transmission with enhanced security. In addition to general data exchange between terminals, UWB communication technology is attracting great attention as a technology that precisely measures the relative position or distance between terminals indoors and outdoors, controls access to buildings or vehicles without close contact between terminals, or enables payment in shops or public transportation.

Such UWB communication technology is applied to a mobile terminal such as a smart phone or the like, or is mounted on a device manufactured for the purpose of providing a special service based on UWB communication (hereinafter referred to as a ‘UWB communication device’).

However, the UWB communication device can only be used for a specific service, and it is difficult to apply it to a service for other purposes. For example, when a UWB communication device manufactured to provide the first service is purchased, the UWB communication device can be used only for the first service and cannot be applied to other services such as the second service and the third service. Accordingly, when a user wants to use the UWB communication device for a second service having a different purpose, it is necessary to purchase an additional UWB communication device manufactured according to the second service.

Accordingly, there is an increasing demand for a UWB communication device that can be reused according to a service purpose.

### SUMMARY

The technical object of the present disclosure is to provide a method and apparatus for managing an application of a short-range communication device so that the short-range communication device can be used in various service fields having a desired purpose.

Another object of the present disclosure is to provide an application management method and apparatus for installing an application in a short-range communication device or deleting an already installed application in a simple manner.

Another object of the present disclosure is to provide an application management method and apparatus for improving security when installing or deleting an application.

The objects of the present disclosure are not limited to the objects mentioned above, and other objects not mentioned will be clearly understood by those skilled in the art of the present disclosure from the description below.

According to some embodiments of the present disclosure, there is provided a method for managing an application in a short-range communication device. The method comprises receiving application installation request information from an administrator of the short-range communication device, generating authentication information for installing the application by using the received application installation request information, requesting a first server to verify the authentication information, downloading application installation data based on a verification of the authentication information, and installing the application in an application platform region of the short-range communication device using the application installation data, and installing an applet for interworking with the application in a secure element of the short-range communication device.

According to another embodiments of the present disclosure, there is provided a method for managing an application in a short-range communication device. The method comprises receiving application installation request information including authentication information from an administrator of the short-range communication device, forming a session with a first server for installing the application and generating a session key, encrypting the authentication information using the session key, requesting the first server to verify the encrypted authentication information, receiving application installation data from the first server based on a verification of the authentication information, and installing the application in an application platform region of the short-range communication device using the application installation data.

According to another embodiments of the present disclosure, there is provided a computing device. The computing device comprises one or more processors, a memory for loading a computer program executed by the processor, and a storage for storing the computer program, wherein the computer program includes instructions for performing operations comprising receiving application installation request information from an administrator, generating authentication information for installing the application using the received application installation request information, requesting a first server to verify the authentication information, downloading application installation data based on a verification of the authentication information, and installing the application in an application platform region of the short-range communication device using the application installation data, and installing an applet for interworking with the application in a secure element of the short-range communication device.

### BRIEF DESCRIPTION OF THE DRAWINGS

These and/or other aspects will become apparent and more readily appreciated from the following description of the embodiments, taken in conjunction with the accompanying drawings in which:

FIG. 1 is a diagram illustrating an application management system, according to an embodiment of the present disclosure;

FIG. 2 is a block diagram illustrating a configuration of a short-range communication device according to an embodiment of the present disclosure;

FIG. 3 is a flowchart illustrating a procedure, in which a list of public keys of provisioning authorities is stored in a short-range communication device, according to an embodiment of the present disclosure;

FIG. 4 is a flowchart illustrating operations processed by an agent and an application executed in a short-range communication device in the embodiment described with reference to FIG. 3;

FIG. 5 is a flowchart illustrating a procedure, in which an application is installed in a short-range communication device according to an embodiment of the present disclosure;

FIG. 6 is a flowchart illustrating in more detail a routine, in which a second application is selected, in the embodiment described with reference to FIG. 5;

FIG. 7 is a flowchart illustrating in more detail a routine for verifying installation of a second application in the embodiment described with reference to FIG. 5;

FIG. 8 is a flowchart illustrating in more detail a procedure, in which a second applet is installed in the embodiment described with reference to FIG. 5;

FIG. 9 is a block diagram exemplarily illustrating a configuration of a short-range communication device, in which a second application and a second applet are installed;

FIG. 10 is a flowchart illustrating a procedure, in which an application is deleted in a short-range communication device according to an embodiment of the present disclosure;

FIG. 11 is a flowchart illustrating operations for deletion processing by an agent and an application executing in a short-range communication device in the embodiment described with reference to FIG. 10;

FIG. 12 is a flowchart illustrating a procedure, in which an application is installed in a short-range communication device according to another embodiment of the present disclosure.

FIG. 13 is a flowchart illustrating in more detail a routine in which a provisioning authority is selected, in the embodiment described with reference to FIG. 12;

FIG. 14 is a flowchart illustrating in more detail a routine for verifying installation of a third application in the embodiment described with reference to FIG. 12;

FIG. 15 is a flowchart illustrating a procedure in which an application is deleted in a short-range communication device according to another embodiment of the present disclosure;

FIG. 16 is a flowchart illustrating operations for deletion processing by an agent and an application executing in a short-range communication device in the embodiment described with reference to FIG. 15;

FIG. 17 is a hardware configuration diagram of a terminal device according to some embodiments of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

The terms “comprise”, “include”, “have”, etc. when used in this specification, specify the presence of stated features, integers, steps, operations, elements, components, and/or combinations of them but do not preclude the presence or addition of one or more other features, integers, steps, operations, elements, components, and/or combinations thereof.

Hereinafter, some embodiments of the present disclosure will be described with reference to the drawings.

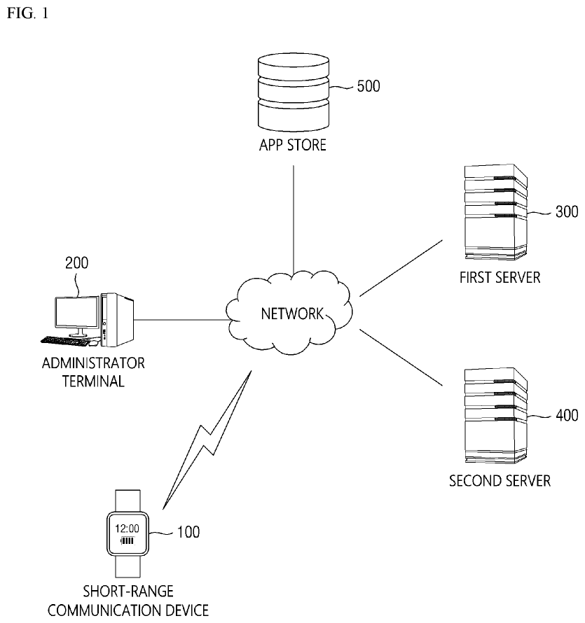

FIG. 1 is a diagram illustrating an application management system, according to an embodiment of the present disclosure.

The application management system according to this embodiment, as shown in FIG. 1, may comprise the short-range communication device 100, the administrator terminal 200, the first server 300, the second server 400 and the app store 500.

The short-range communication device 100 illustrated in FIG. 1 may be loaded with one or more applications operating based on short-range communication, and may perform a requested service by using the applications. In FIG. 1, the short-range communication device 100 is exemplified in the form of a wrist watch mounted on the wrist, but the present disclosure is not limited thereto and the short-range communication device 100 may be manufactured in the form of a card, necklace, glasses, ring, bracelet and the like.

The administrator terminal 200 may be a terminal used by an administrator who manages the short-range communication device 100. For example, the administrator may belong to an authority or organization that purchased or rented the short-range communication device 100. The administrator terminal 200 may register the installation data of the application in the app store 500 through the first server 300 and may register the installation data of the applet related to the application in the second server 400.

The first server 300 may be a server built by an Application Platform Provisioning Authority that manages one or more applications and permits UWB services for the applications. The first server 300 may register the application installation data received from the administrator terminal 200 in the app store 500, and may also register the applet installation data in the second server 400. In addition, the first server 300 may perform verification for installation or deletion of the application.

The second server 400 may store a list of PA public keys including public keys for each of one or more provisioning authorities (hereinafter, referred to as “PA”). The second server 400 may be a server built by a company or an authority that has produced the short-range communication device 100. The second server 400 may store installation data of the applet installed in the secure element of the short-range communication device 100. Also, the second server 400 may store data that may be stored in a secure element included in the short-range communication device 100.

The app store 500 may store various application-related data. The app store 500 may classify and store applications dedicated to the short-range communication device into a separate category.

The short-range communication device 100 shown in FIG. 1 is equipped with one or more applications that can operate through short-range communication, and can provide a special-purpose service based on short-range communication to the user by using the application. Services based on short-range communication may include, for example, attendance check, seat occupancy check, entry/exit management, indoor movement route tracking, indoor navigation service, transportation payment, and the like.

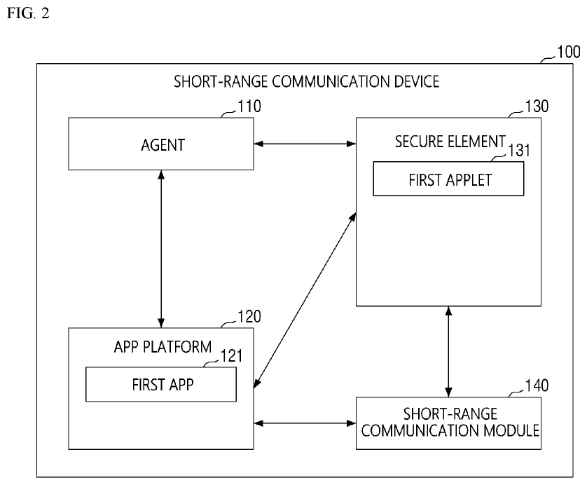

Hereinafter, another short-range communication device 100 in FIG. 1 will be described in more detail with reference to FIG. 2.

As illustrated in FIG. 2, the short-range communication device 100 may include an agent 110, an application platform 120, a secure element 130, and a short-range communication module 140. The short-range communication device 100 may additionally include a display, an input means, a long-range communication module, and the like.

The short-range communication module 140 may exchange data with another communication device based on a short-range protocol. The short-range communication module 140 may include one or more communication modules that support at least some of communication technologies such as NFC (Near Field Communication), Bluetooth (Bluetooth), BLE (Bluetooth Lowe Energy), UWB (Ultra-Wide Band), WiFi, etc.

The agent 110 may manage data stored in the secure element 130. In an embodiment, the agent 110 may obtain data from the second server 400, and store the data obtained by using the first applet 131 in the secure element 130. Also, the agent 110 may delete data stored in the secure element 130 by using the first applet 131. In addition, the agent 110 may interwork with the first server 300 to perform verification for installation or deletion of the application.

The application platform 120 is a region, in which applications are installed, and various applications may be installed therein. The application platform 120 is a default application, and the first application 121 may be installed. In an embodiment, the first application 121 may communicate with the administrator terminal 200 to perform a routine for installing another application.

The secure element 130 may be a region, in which important data that should not be exposed to the outside is stored. Access to the secure element 130 may be limited to only a small portion of hardware mounted on the short-range communication device 100 or software running in the short-range communication device 100, for example, only the agent 110, and the other elements of the short-range communication device 100 may be configured to access the secure element 130 only through the agent 110.

The secure element 130 may be allocated a predetermined storage space. A first applet 131 that is a system applet for generating or verifying authentication information may be installed in the secure element 130. The first applet 131 may be installed in the secure element 130 by default when the short-range communication device 100 is shipped. The first applet 131 may interwork with the agent 110 to store data in the secure element 130 or delete data in the secure element 130. Also, the first applet 131 may generate authentication information for installing the second application. As will be described later, a second applet that interworks with a second application may be additionally installed in the secure element. Here, the second application may provide a special purpose service using transmission/reception data based on short-range communication. In addition, the second applet may obtain data processed in the secure element 130 by interworking with the second application.

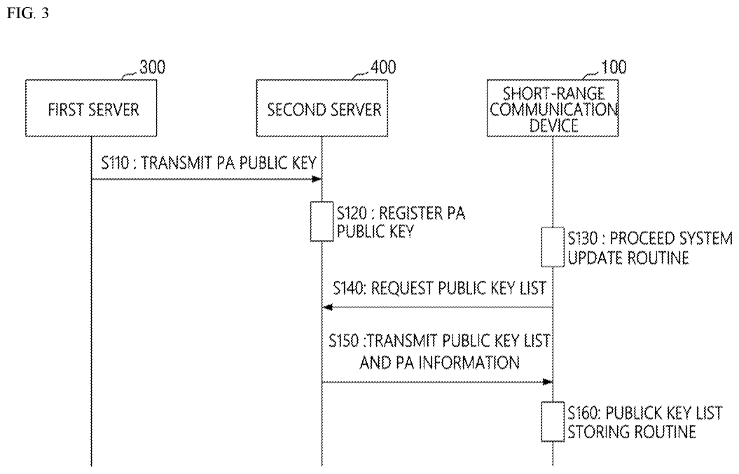

A method, in which the short-range communication device 100 interworks with the administrator terminal 200, the first server 300, and the second server 400 to manage an application, will be described with referenced to FIGS. 3 to 11.

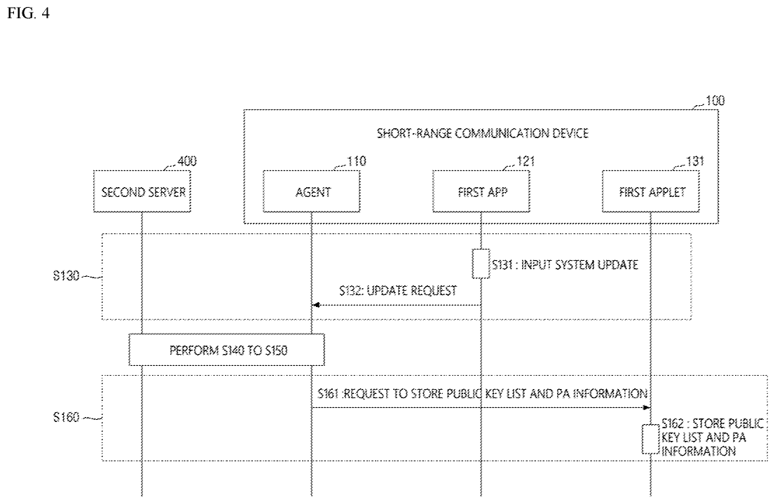

A procedure for storing a PA public key list in a short-range communication device according to an embodiment of the present disclosure will be described with reference to FIGS. 3 and 4.

In step S110 of FIG. 3, in order to register the PA public key in the second server 400, the first server 300 may transmit one or more PA public keys and PA identification information to the second server 400. Here, the at least one PA public key may be a public key obtained from a provisioning authority that provides an application.

In step S120, the second server 400 may register one or more received PA public keys and PA identification information. Accordingly, one or more PA public keys mapped with the PA identification information, that is, the PA public key list and the PA list may be stored together. In addition, the second server 400 may store PA information including a Uniform Resource Locator (URL) for the PA, and may store the PA information in advance by mapping it with PA identification information. Accordingly, one or more PA public keys and PA information related to PA identification information may be stored in the second server 400.

In step S130, the short-range communication device 100 may perform a system update routine according to an input of an administrator.

Referring to FIG. 4 described in more detail for step S130, in step S131, the first application 121 of the short-range communication device 100 may receive system update request information from an administrator. In an embodiment, the short-range communication device 100 may receive the system update request information through a physically formed input means (e.g., an input button or a touch screen). In another embodiment, the short-range communication device 100 may communicate with the administrator terminal 200 in wireless or wire communication, and may receive system update request information from the administrator terminal 200 through communication.

As the system update request information is input, in step S132, the first application 121 may request a system update to the agent 110.

Referring back to FIG. 3, in step S140, the short-range communication device 100 may request the public key list to the second server 400. The step S140 may be performed by the agent 110 of the short-range communication device 100.

Subsequently, in step S150, the second server 400 may transmit a PA list including one or more PA identification information, a public key list mapped to each PA identification information, and PA information to the short-range communication device 100.

In step S160, the short-range communication device 100 may proceed with a routine for storing the PA list, the PA public key list, and PA information.

Referring to FIG. 4 described in more detail for step S160, in step S161, the agent 110 of the short-range communication device 100 may request storage of the PA list, the public key list, and the PA information by transferring a PA list including one or more PA identification information, a PA public key list mapped to each PA identification information, and PA information to the first applet 131 installed in the secure element 130. Here, the PA information may include a URL corresponding to the PA.

In step S162, the first applet 131 of the short-range communication device 100 may store the PA list, the PA public key list, and PA information received from the agent 110 in the secure element 130.

According to the present embodiment, the PA list, the PA public key list, and the PA information may be stored in the secure element 130 through interworking between the agent 110 and the first applet 131. As will be described later, the PA list, the PA public key list, and the PA information may be used to install or delete the second application.

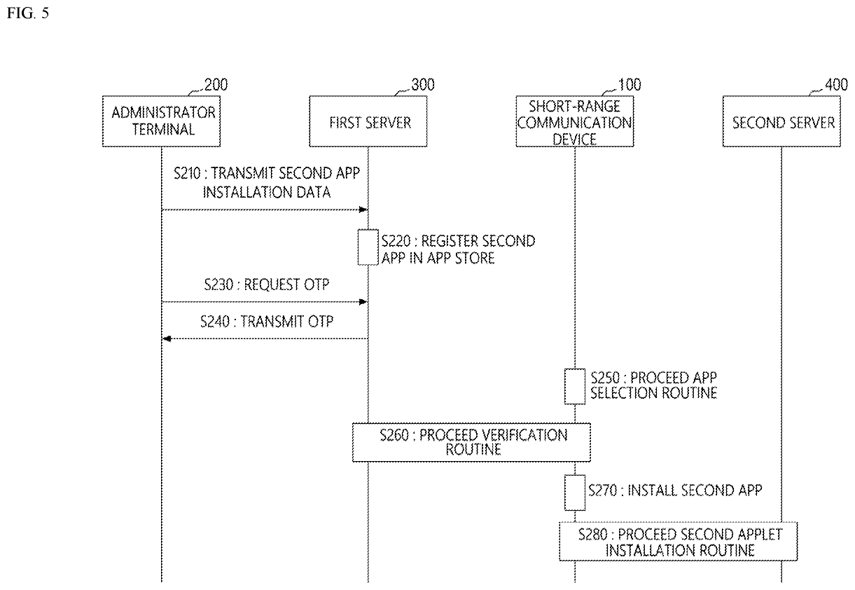

Hereinafter, a procedure for installing the second application in the short-range communication device 100 will be described with reference to FIGS. 5 to 9.

First, before describing the process of installing the second application in the short-range communication device 100, the process, in which information about the second application is pre-registered in the first server 300, will be described with reference to step S210 to step S220 of FIG. 5.

In step S210, the administrator terminal 200 may transmit second application installation data dedicated to the short-range communication device and identification information of the second application to the first server 300. Additionally, the administrator terminal 200 may transmit installation data of the second applet interworking with the second application to the first server 300. In an embodiment, the administrator terminal 200 may set that the second application is an application dedicated to the short-range communication device by selecting a short-range communication device category from among a plurality of preset categories.

In step S220, the first server 300 may register the second application in the app store 500 by storing the second application identification information and the second application installation data in the app store 500. At this time, the first server 300 does not store the installation data of the second applet in the app store 500, and may transmit the installation data of the second applet to the second server 400 when the installation verification is successful as described below.

Hereinafter, for example, an exemplary process, in which the administrator of the short-range communication device 100 installs the second application previously registered in the first server 300 in the short-range communication device 100, will be described with reference to step S230 to step S280 of FIG. 5.

After the second application is registered in the app store 500, in step S230, the administrator terminal 200 may request a One Time Password (OTP) for installing the second application to the first server 300.

Subsequently, in step S240, the first server 300 may generate an OTP and transmit the generated OTP to the administrator terminal 200. In some embodiments, the first server 300 may generate a password in another form instead of the OTP and transmit it to the administrator terminal 200. In this case, a password in another form may be used as information for authentication instead of the OTP.

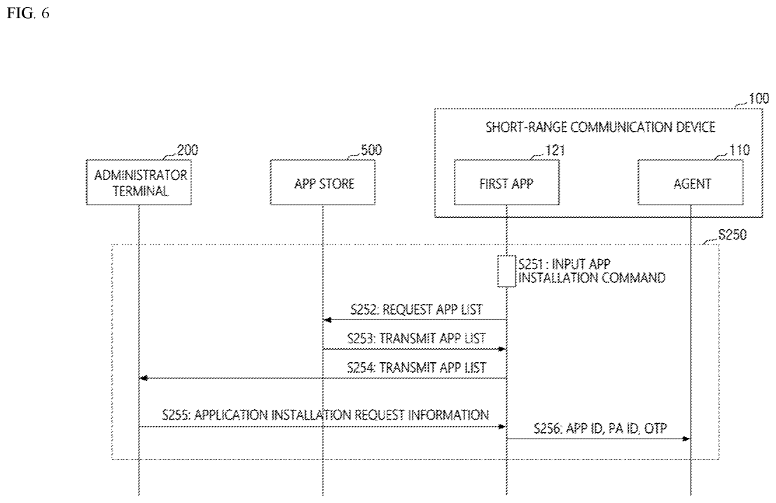

In step S250, the short-range communication device 100 may perform a routine, in which a second application is selected from one or more applications registered in the app store 500. Step 250 is described in more detail with reference to FIG. 6.

Referring to FIG. 6, in step S251, the first application 121 of the short-range communication device 100 may receive an application installation command from an administrator.

In response to the input of the application installation command, steps S252 and S253 are performed, and the first application 121 may request a list of applications that can be installed and executed in the same type of device as the short-range communication device 100 to the app store 500, and accordingly, obtain a list of applications dedicated to the short-range communication device from the app store 500. In this embodiment, the second application may be understood as one of applications that may be executed in the short-range communication device 100.

In step S254, the first application 121 may transmit the obtained short-range communication device dedicated application list to the administrator terminal 200. Accordingly, the application list may be displayed on the administrator terminal 200. In some embodiments, an application list of the first application 121 may be displayed on a display means (e.g., a touch screen) of the administrator terminal 200.

In response to the administrator selecting a specific application from the application list, in step S255, the first application 121 of the short-range communication device 100 may receive application installation request information including the identification information of the selected application, PA identification information, and OTP (One Time Password) from an administrator. In an embodiment, the PA identification information and the OTP may be input by an administrator. In this embodiment, it may be understood that the OTP issued by the PA is the OTP transmitted from the first server 300 to the administrator terminal 200. Also, in the present embodiment, it may be understood that the administrator selects the second application as an installation target from the application list. As illustrated in FIG. 6, the first application 121 of the short-range communication device 100 may receive the application installation request information from the administrator terminal 200 through wireless or wired communication with the administrator terminal 200. In another embodiment, the short-range communication device 100 may receive the application installation request information from the administrator through a physically formed input means of the short-range communication device 100.

In step S256, the first application 121 of the short-range communication device 100 may transfer the application identification information (i.e., the second application identification information), the PA identification information, and the OTP included in the application installation request information to the agent 110.

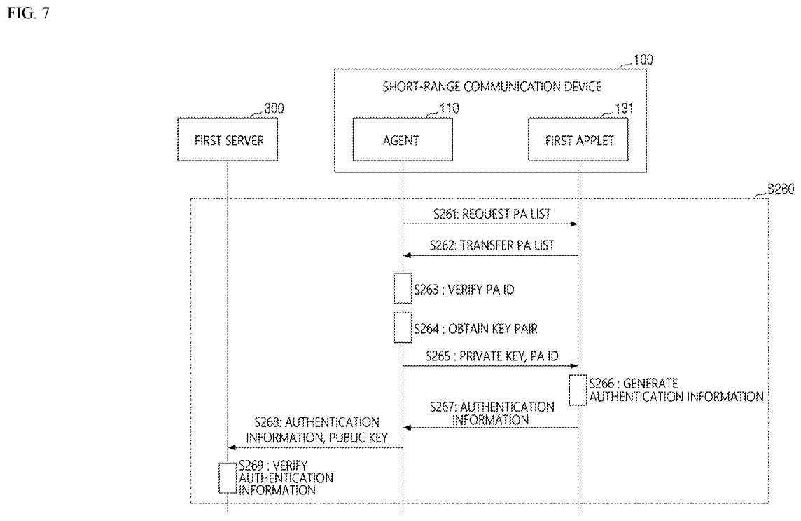

Referring back to FIG. 5, in step S260, the short-range communication device 100 may interwork with the first server 300 to perform a routine of verifying the installation of the second application. Step S260 will be described in more detail with reference to FIG. 7.

In step S261 of FIG. 7, the agent 110 of the short-range communication device 100 may request the PA list to the first applet 131 installed in the secure element 130.

In step S262, the first applet 131 may obtain the PA list including one or more PA identification information and PA information stored in the secure element 130 and transfer them to the agent 110.

In step S263, the agent 110 may verify the PA identification information by determining whether the PA identification information received from the first application 121 is recorded in the PA list. If the PA identification information is not recorded in the PA list, the agent 110 may stop the installation of the second application without proceeding it.

In response to the determination that the PA identification information is recorded in the PA list, step S264 may proceed, so that the agent 110 may obtain a key pair. In one embodiment, the agent 110 may generate a key pair comprising of a first private key and a first public key using a predefined key generation algorithm. In another embodiment, the agent may obtain a first private key and a first public key that are previously generated and stored.

In step S265, the agent 110 may transfer the first private key and the identification information of the provisioning authority to the first applet 131 for OTP encryption. In one embodiment, the agent 110 may also transfer the OTP to the first applet 131.

In step S266, the first applet 131 may obtain a public key (hereinafter, referred to as a “second public key”) corresponding to the provisioning authority from the secure element 130, and generate the authentication information based on the second public key and the first private key. In one embodiment, the first applet 131 may generate a security key using the second public key and the first private key, encrypt the OTP using the security key, and then generate the authentication information including the encrypted OTP. The first applet 131 may generate the security key by inputting the second public key and the first private key into a predefined security key generation algorithm. As the predefined security key generation algorithm, an elliptic-curve Diffie-Hellman algorithm may be used.

In step S267, the first applet 131 may transfer the generated authentication information to the agent 110.

Next, in step S268, the agent 110 may request verification of the authentication information by transmitting the authentication information and the first public key to the first server 300. In an embodiment, the agent 110 may obtain a URL corresponding to the PA identification information from the PA information obtained from the secure element 130, and request verification of the authentication information to a server corresponding to the URL. In this embodiment, it may be understood that the URL corresponding to the PA identification information is the address of the first server 300. In an embodiment, the agent 110 may transmit the PA identification information input by the administrator to the first server 300.

In step S269, the first server 300 may obtain a second private key (i.e., PA private key) corresponding to the received PA identification information, and decrypt the encrypted OTP based on the first public key and the private kye of the provisioning authority (PA), and then verify whether the decrypted OTP matches the OTP transmitted to the administrator terminal 200. In one embodiment, the first server 300 may obtain a second private key corresponding to the identification information of the provisioning authority received from the short-range communication device 100, generate the same security key as the security key generated by the short-range communication device 100 by inputting the second private key and the public key into the pre-defined security key generation algorithm, and then decrypt the encrypted OTP using the security key. Here, the security key may be a symmetric key, and the PA private key may be stored in advance in the first server 300. As the predefined security key generation algorithm, an elliptic-curve Diffie-Hellman algorithm may be used. The first server 300 may transmit the verification result of the authentication information to the agent 110 of the short-range communication device 100.

Referring back to FIG. 5, in response to successful verification of the authentication information in the first server 300, the short-range communication device 100 may install the second application in step S270. In an embodiment, if verification of the authentication information is successful, the second application may be installed in the application platform region 120 included in the short-range communication device 100 using the second application installation data.

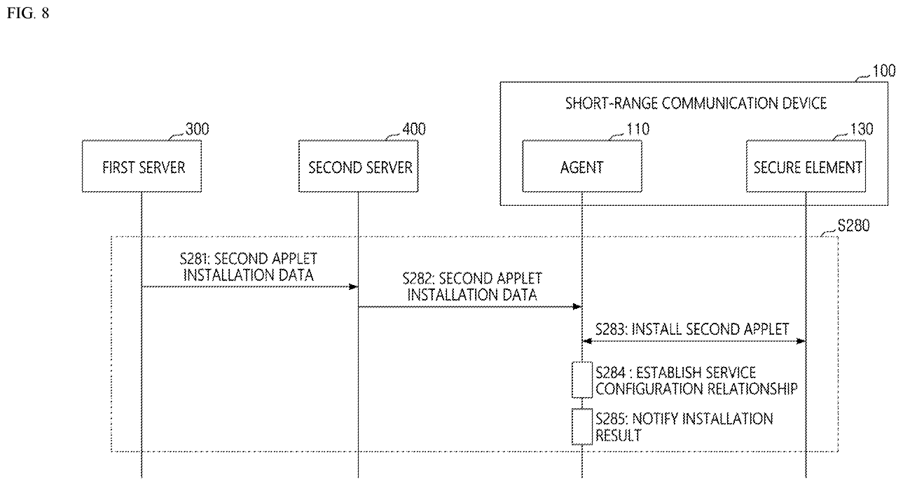

Next, in step S280, the short-range communication device 100 may proceed the routine of obtaining the installation data of the second applet, and using the obtained installation data of the second applet to install the second applet in the secure element 130. The second applet may be an applet that interworks with a second application. Step S280 will be described in more detail with reference to FIG. 8.

Referring to FIG. 8, in step S281, the first server 300 may transmit applet installation request information including second applet installation data to the second server 400 in response to successful verification of the authentication information. In this case, the first server 300 may transmit identification information of the short-range communication device 100 to the second server 400 to identify a device to be installed.

Subsequently, in step S282, the second server 400 may transmit the second applet installation data to the agent 110 of the short-range communication device 100 in response to receiving the applet installation request information.

In step S283, the agent 110 may install the second applet in the secure element 130 using the second applet installation data. In one embodiment, the agent 110 may transfer the second applet installation data to the first applet 131, and the first applet 131 may install the second applet in the secure element 130 based on the second applet installation data.

In step S283, the agent 110 may establish a service configuration relationship between the second application installed in the application platform 120 and the second applet installed in the secure element 130. When establishing the service configuration relationship, the agent 110 may set the authority to allow the second application to access the second applet. Also, when establishing the service configuration relationship, the agent 110 may establish a function call relationship between the second application and the second applet, a code connection relationship, a class connection configuration, an object connection configuration, a parameter relationship, and the like.

In step S285, the agent 110 may notify the installation result of the second application and the second applet to the administrator terminal 200.

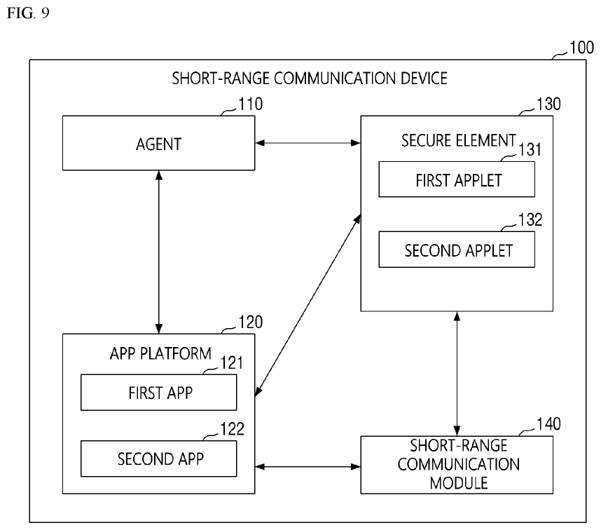

FIG. 9 is a diagram illustrating the short-range communication device 100, in which the second application 122 and the second applet 132 are installed.

As illustrated in FIG. 9, when the installation is normally completed, the second application 122 may be additionally installed in the application platform 120, and the second applet 132 may be additionally installed in the secure element 130.

According to the present embodiment, in addition to the second application 122 and the second applet 132, applications and applets for supporting various services may be installed in the application platform 120 and the secure element 130, respectively. Accordingly, the administrator may load one or more applications and applets required for a service on the short-range communication device 100 according to a customer request.

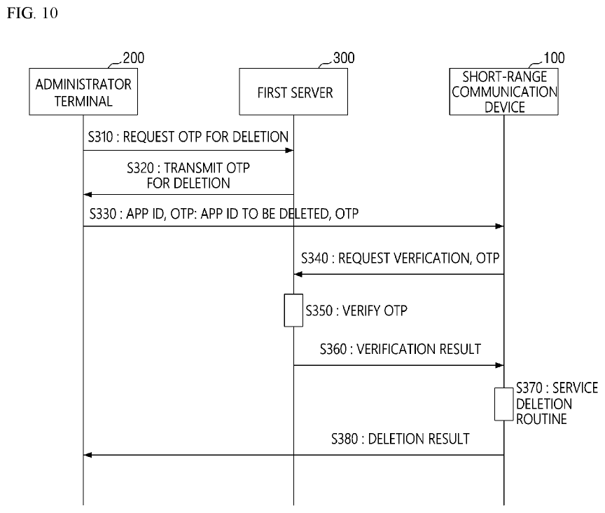

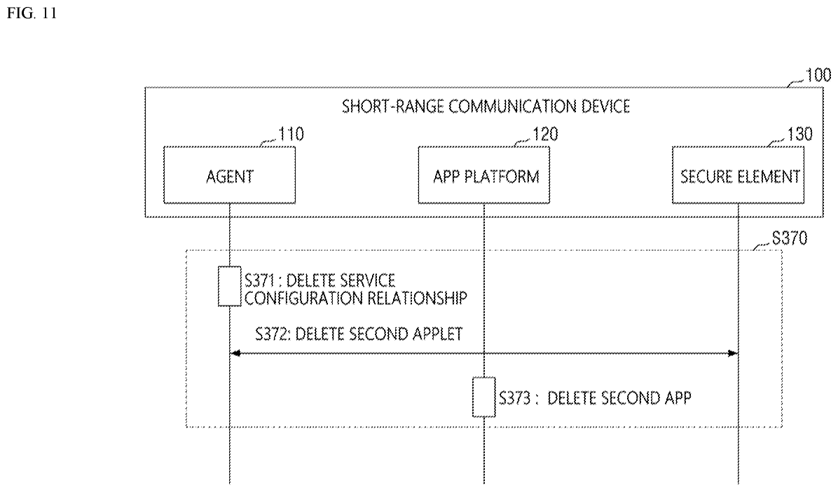

Hereinafter, a procedure for deleting the second application 122 from the short-range communication device 100 will be described with reference to FIGS. 10 and 11.

In step S310, the administrator terminal 200 may request an OTP for deletion for deleting the second application 122 to the first server 300.

Subsequently, in step S320, the first server 300 may generate an OTP for deletion and transmit the generated OTP for deletion to the administrator terminal 200. In some embodiments, the first server 300 may generate a password in another form instead of the OTP and transmit it to the administrator terminal 200. In this case, a password in another form instead of the OTP may be used as information for deletion authentication.

In step S330, the short-range communication device 100 may receive application deletion request information from the administrator. In an embodiment, the short-range communication device 100 may receive application deletion request information including identification information of an application to be deleted, PA identification information, and an OTP for deletion from an administrator. As illustrated in FIG. 10, the short-range communication device 100 may receive the application deletion request information from the administrator terminal 200 through wireless or wired communication with the administrator terminal 200. In another embodiment, through a physically implemented input means in the short-range communication device 100, the short-range communication device 100 may receive the application deletion request information from the administrator.

In step S340, the short-range communication device 100 may request verification of the deletion of the second application by transmitting the OTP for deletion received from the administrator terminal 200 to the first server 300.

In step S350, the first server 300 may determine whether the OTP for deletion received from the short-range communication device 100 matches the OTP for deletion transmitted to the administrator terminal 200 to perform OTP verification.

In another embodiment, the short-range communication device 100 may encrypt the OTP for deletion and transmit it to the first server 300 as in steps S264 to S268 of FIG. 7. In this case, the first server 300 may determine whether the OTP for deletion is correct after decrypting the encrypted OTP for deletion, as in step S269.

In step S360, the first server 300 may transmit the verification result of the OTP for deletion to the short-range communication device 100.

In step S370, the short-range communication device 100 may proceed with a routine of deleting the second application in response to receiving the verification success as the verification result. Step S370 will be described in more detail with reference to FIG. 11.

In step S371 of FIG. 11, the short-range communication device 100 may delete a service configuration relationship formed between the second application and the second applet.

Subsequently, in step S372, the agent 110 may delete the second applet 132 from the secure element 130. In an embodiment, the agent 110 may request the first applet 131 to delete the second applet, and the first applet 131 may delete the second applet 132 from the secure element 130.

Next, in step S373, the second application 122 may be deleted from the application platform 120. In an embodiment, in response to successful verification of the OTP for deletion, the first application 121 may delete the second application 122 from the application platform 120.

As described above, as an application may be installed or deleted in the short-range communication device 100, convenient reuse of the short-range communication device 100 may be possible. That is, the administrator may install an application according to the service purpose in the short-range communication device 100 or delete the installed application from the short-range communication device 100. In addition, according to the present embodiment, the effect of improving the security and stability of data in the secure element 130 may be exhibited by blocking the service-related second application 122 to directly access to the secure element 130, and allowing to obtain data processed in the secure element 130 only through the second applet 132 of the secure element 130. In addition, since the application is installed/deleted in the short-range communication device 100 through installation/deletion verification, it is possible to exert a strong effect against external hacking.

In the above-described embodiment, it has been described that the second application 122 and the second applet 132 are installed together in the short-range communication device 100, but in some embodiments, only the second application 122 can be installed in the application platform 120. That is, only the application may be installed in the application platform 110 without the applet being installed.

Meanwhile, even in a system environment, in which the app store 500 is not included, the application management method according to the present disclosure may be applied.

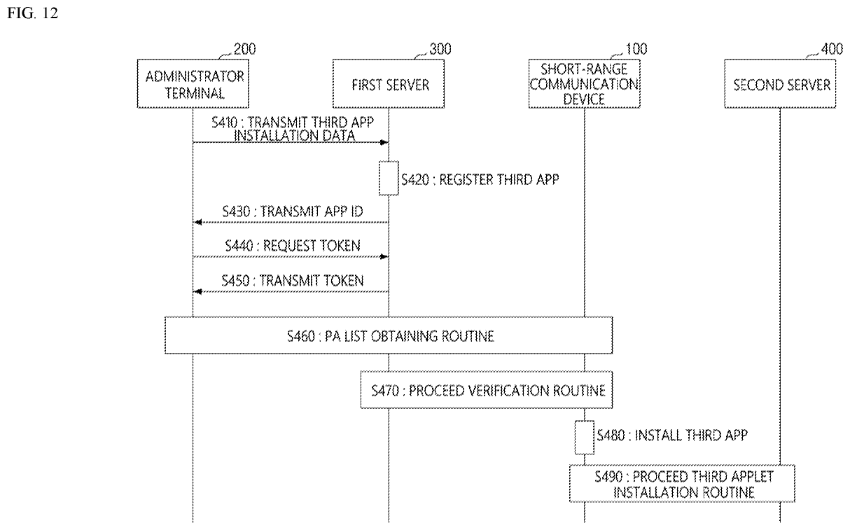

Hereinafter, another embodiment of a method of managing an application without using the app store 500 will be described with reference to FIGS. 12 to 16.

A procedure for installing a third application in the short-range communication device 100 according to another embodiment of the present disclosure will be described with reference to FIGS. 5 to 14.

In step S410, the administrator terminal 200 may transmit the third application installation data dedicated to the short-range communication device to the first server 300. Additionally, the administrator terminal 200 may transmit installation data of the third applet interworking with the third application to the first server 300.

In step S420, the first server 300 allocates the identification information of the third application, and stores the allocated identification information and the third application installation data in the storage area of the first server 300, so that the third applications can be registered. In one embodiment, the first server 300 may obtain a hash of the installation data of the third application, electronically sign the obtained hash with the private key of the first server 300, and then store the electronic signature in advance.

In step S430, the first server 300 may transmit the allocated identification information of the third application to the administrator terminal 200.

After the third application is registered in the third server 300, in step S440, the administrator terminal 200 may request a token for installing the third application to the first server 300. The token is one-time use, and may be generated each time a token is requested to be generated.

In step S450, the first server 300 may generate a token and transmit the token to the administrator terminal 200. In some embodiments, the first server 300 may generate a password in another form instead of a token and transmit it to the administrator terminal 200. In this case, a password in another form instead of the token may be used as information for authentication.

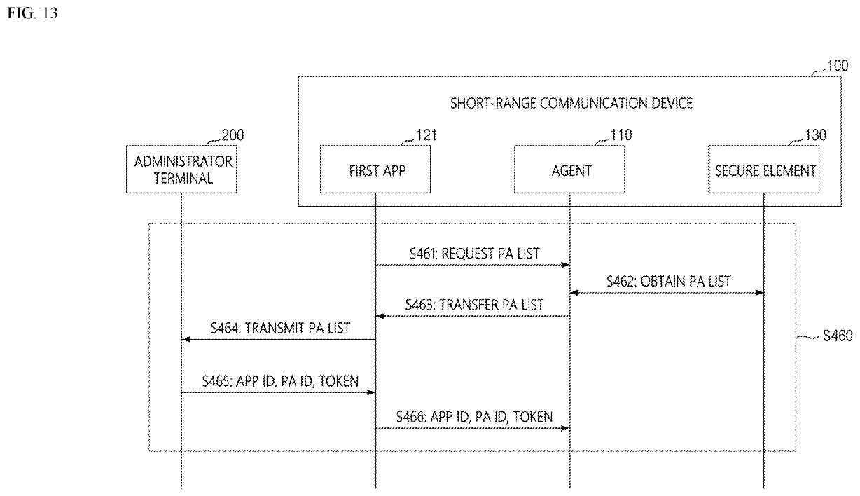

In step S460, the short-range communication device 100 may perform a routine of selecting a PA by interworking with the administrator terminal 200. Step S460 will be described in more detail with reference to FIG. 13.

Referring to FIG. 13, the short-range communication device 100 may request a PA list to the agent 110 in step S461 in response to the administrator's application installation command.

In step S462, the agent 110 may obtain the PA list stored in the secure element 130. In an embodiment, the agent 110 may request a PA list to the first applet 131 of the secure element 130, and obtain the PA list from the first applet 131.

In step S463, the agent 110 may transfer the PA list to the first application 121.

In step S464, the first application 121 may transmit the PA list to the administrator terminal 200. In another embodiment, the first application 121 may display the PA list.

The administrator may select any one provisioning authority (PA) from the PA list, and may input the identification information of the third application and token received from the first server 300. In this case, in step S465, the first application 121 of the short-range communication device 100 may obtain the PA identification information selected by the administrator, the identification information of the third application and the token. As illustrated in FIG. 13, the first application 121 of the short-range communication device 100 may receive the PA identification information, and the identification information of the third application and the token from the administrator terminal 200 through wireless or wired communication with the administrator terminal 200. In another embodiment, the short-range communication device 100 may receive the identification information of the provisioning authority, the identification information of the third application and the token from the administrator through the physically implemented input means of the short-range communication device 100.

In step S466, the first application 121 may transfer the received PA identification information, the identification information of the third application, and the token to the agent 110.

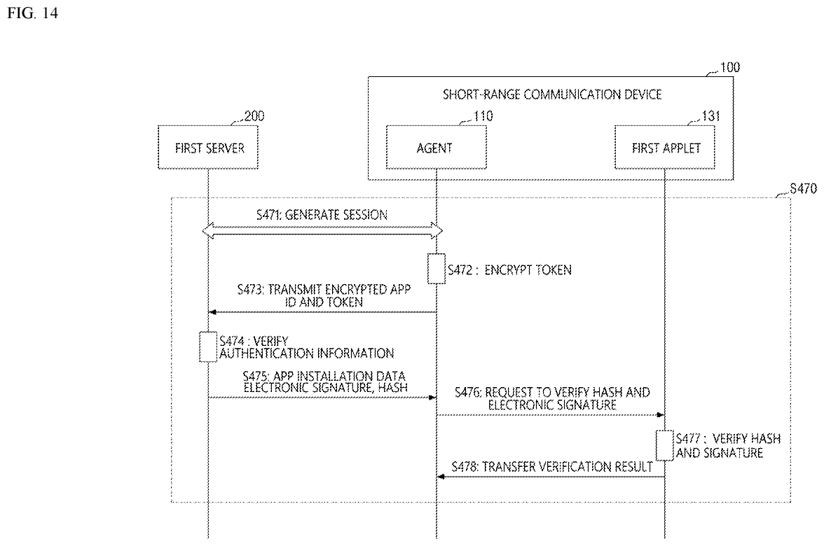

Referring back to FIG. 12, a verification routine for the installation of the third application may be performed in step S470. Step S470 will be described in more detail with reference to FIG. 14.

In step S471 of FIG. 14, the agent 110 of the short-range communication device 100 may establish a first session with the first server 300. In one embodiment, the agent 110 may obtain a URL corresponding to the PA identification information input from the administrator from the PA information stored in the secure element 130, and may identify that a server to be accessed is the first server 300 using the obtained UR. In an embodiment, the agent 110 may obtain the URL by interworking with the first applet 131. In an embodiment, the short-range communication device 100 may generate a key for the first session (hereinafter, referred to as a “first session key”) using a preset session key generation algorithm. The short-range communication device 100 may establish a first session with the first server 300 through long-range communication using a network. In an embodiment, the short-range communication device 100 may generate the first session key by using one or more of the public key of the short-range communication device 100, the public key of the first server 300, and the current date and time. In some embodiments, the short-range communication device 100 may generate a temporary public key and generate the first session key using one or more of the temporary public key and the current date and time. The short-range communication device 100 may share the temporary public key or the public key of the short-range communication device 100 with the first server 300.

In step S472, the agent 110 of the short-range communication device 100 may encrypt the received token and the identification information of the third application by using the first session key.

In step S473, the agent 110 of the short-range communication device 100 transmits authentication information including the encrypted token and the identification information of the third application to the first server 300 to request verification of the authentication information.

In step S474, the first server 300 may verify the authentication information by decrypting the encrypted token and the identification information of the third application using the first session key. In an embodiment, the first server 300 may obtain the first session key using the same session key generation algorithm used in the short-range communication device 100. The first server 300 may verify the authentication information by determining whether the decrypted identification information of the third application is correct, and also determining whether the decrypted token matches the token transmitted to the administrator terminal 200.

In response to successful verification of the authentication information, the first server 300 may transmit the installation data of the third application, the electronic signature, and the hash of the third application to the short-range communication device 100 in step S475. Here, the electronic signature may be generated based on the hash of the third application and the private key of the first server 300.

In step S476, the agent 110 of the short-range communication device 100 may request verification of the hash and the electronic signature to the first applet 131 installed in the secure element 130. In this case, the agent 110 may provide the hash, the electronic signature, and the installation data of the third application to the first applet 131.

In step S477, the first applet 131 may calculate a hash for the installation data of the third application, determine whether the calculated hash matches the hash received from the agent 110, and determine the authenticity of the electronic signature of the first server 300 as well. In an embodiment, the first applet 131 may determine the authenticity of the electronic signature by using the previously obtained public key of the first server 300 and the hash.

In step 478, the first applet 131 may transfer the verification result for the hash and the electronic signature to the agent 110.

Meanwhile, in some embodiments, verification of any one of the electronic signature and the hash may be performed without performing verification of both the electronic signature and the hash.

In response to successful verification of the electronic signature and hash, step S480 of FIG. 12, in which the application is installed, may proceed. In an embodiment, if verification of the electronic signature and hash is successful, the third application may be installed in the application platform region 120 included in the short-range communication device 100 using the third application installation data.

Subsequently, in step S490, the short-range communication device 100 may proceed a routine of obtaining the installation data of the third applet, and using the obtained installation data of the third applet to install the third applet in the secure element 13. The third applet may be an applet that interworks with the third application. Since step S490 is similar to step S280 described with reference to FIG. 8, a detailed description thereof will be omitted.

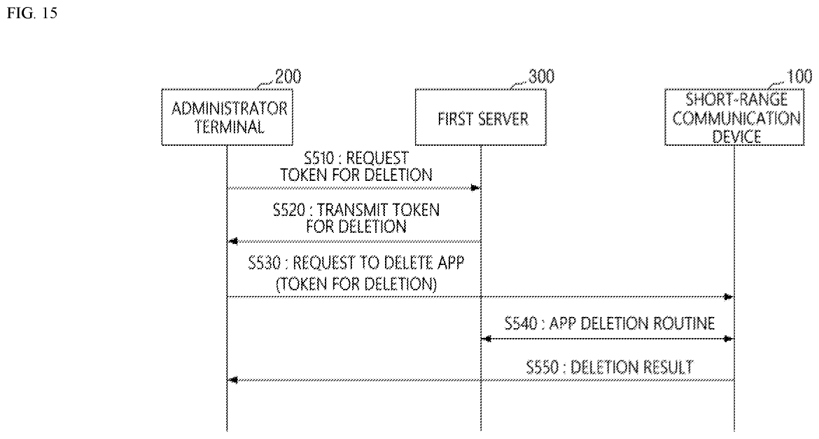

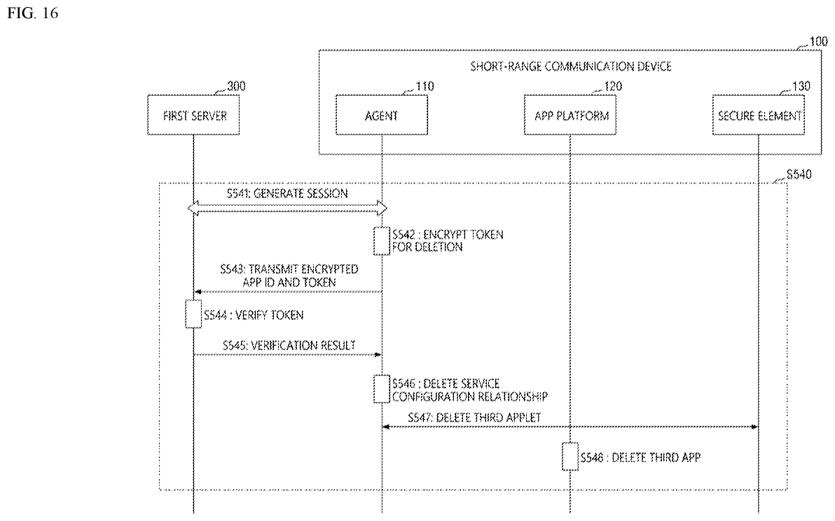

Hereinafter, a procedure for deleting the third application from the short-range communication device 100 will be described with reference to FIGS. 15 and 16.

In step S510, the administrator terminal 200 may request a deletion token for deleting the third application to the first server 300.

Subsequently, in step S520, the first server 300 may generate a token for deletion and transmit the generated token for deletion to the administrator terminal 200. In some embodiments, the first server 300 may generate a password in another form instead of the token and transmit it to the administrator terminal 200, in which case, a password in another form instead of the token will be used as authentication information for application deletion.

In step S530, the short-range communication device 100 may receive application deletion request information from the administrator. In an embodiment, the short-range communication device 100 may receive application deletion request information including identification information of an application to be deleted and a token for deletion from an administrator. As illustrated in FIG. 15, the short-range communication device 100 may receive the application deletion request information from the administrator terminal 200 through wireless or wired communication with the administrator terminal 200. In another embodiment, the short-range communication device 100 may receive the application deletion request information from the administrator through a physically implemented input means of the short-range communication device 100.

In step S540, the short-range communication device 100 may perform a routine for deleting the third application interworking with the first server 300. Step S540 will be described in more detail with reference to FIG. 16.

In step S541 of FIG. 16, the agent 110 of the short-range communication device 100 may establish a second session with the first server 300. In an embodiment, the short-range communication device 100 may obtain the second session key using a preset session key generation algorithm.

In step S542, the agent 110 of the short-range communication device 100 may use the second session key to encrypt the received token for deletion and identification information of the third application to be deleted.

In step S543, the agent 110 of the short-range communication device 100 may transmit the authentication information including the encrypted token for deletion and the identification information of the third application to the first server 300 to request the verification for the deletion of the third application.

In step S544, the first server 300 may use the second session key to decrypt the encrypted token for deletion and the identification information of the third application to verify the deletion of the third application. In an embodiment, the first server 300 may obtain the second session key using the same session key generation algorithm used in the short-range communication device 100. The first server 300 may verify whether the decrypted identification information of the third application is correct, and also verify whether the decrypted token matches the token transmitted to the administrator terminal 200.

In step S545, the first server 300 may transmit the verification result to the agent 110 of the short-range communication device 100.

In response to successful verification of the identification information of the third application and successful verification of the token for deletion, the agent 110 may delete the service configuration relationship formed between the third application and the third applet in step S546.

In step S547, the agent 110 may delete the third applet from the secure element 130. In an embodiment, the agent 110 may request the first applet 131 to delete the third applet, and the first applet 131 may delete the third applet from the secure element 130.

In step S548, the second application 122 may be deleted from the application platform 120. In an embodiment, the first application 121 may delete the third application from the application platform 120.

So far, an application management method and apparatuses according to some embodiments of the present disclosure have been described with reference to FIGS. 1 to 16.

The technical idea of the present disclosure described with reference to FIGS. 1 to 16 may be implemented as computer-readable codes on a computer-readable medium. The computer-readable recording medium may be, for example, a removable recording medium (CD, DVD, Blu-ray disk, USB storage device, removable hard disk) or a fixed recording medium (ROM, RAM, computer-equipped hard disk). The computer program recorded in the computer-readable recording medium may be transmitted to another computing device through a network such as the Internet and installed in the other computing device, thereby being used in the other computing device.

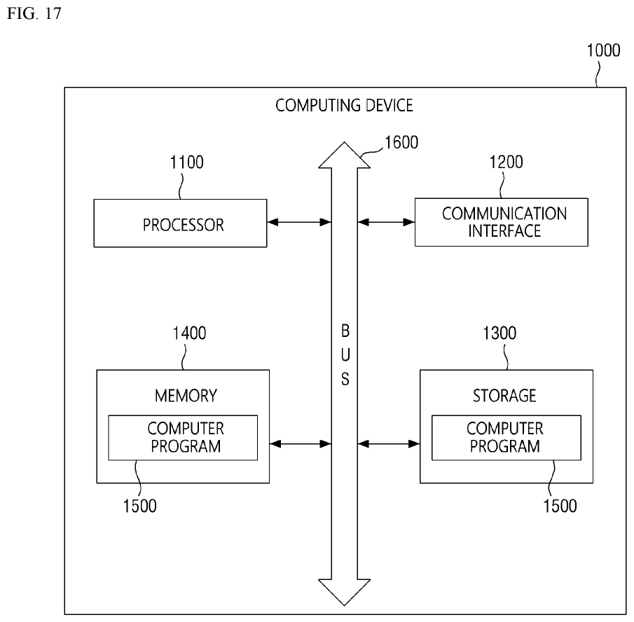

Hereinafter, a hardware configuration of an exemplary computing device according to some embodiments of the present disclosure will be described with reference to FIG. 17. The computing device described with reference to FIG. 17 may be, for example, a hardware configuration of the short-range communication device 100 described with reference to FIG. 2.

FIG. 17 is an exemplary hardware configuration diagram that may implement a computing device in various embodiments of the present disclosure. The computing device 1000 may include one or more processors 1100, a system bus 1600, a communication interface 1200, a memory 1400 for loading a computer program 1500 performed by the processor 1100, and a storage 1300 for storing the computer program 1500.

The processor 1100 controls the overall operation of each component of the computing device 1000. The processor 1100 may include at least one of a central processing unit (CPU), a micro processor unit (MPU), a micro controller unit (MCU), a graphic processing unit (GPU), or any type of processor well known in the art of the present disclosure. In addition, the processor 1100 may perform an operation on at least one application or program for executing the method/operation according to various embodiments of the present disclosure. The computing device 1000 may include two or more processors.

The memory 1400 stores various data, commands, and/or information. The memory 1400 may load one or more computer programs 1500 from the storage 1300 to execute methods/operations according to various embodiments of the present disclosure. An example of the memory 1400 may be a RAM, but is not limited thereto. The system bus 1600 provides a communication function between components of the computing device 1000.

The system bus 1600 may be implemented as various types of buses, such as an address bus, a data bus, and a control bus. The communication interface 1200 supports wired/wireless Internet communication of the computing device 1000. The communication interface 1200 may support various communication methods other than Internet communication. To this end, the communication interface 1200 may be configured to include a communication module well-known in the technical field of the present disclosure. The storage 1300 may non-temporarily store one or more computer programs 1500. The storage 1300 may include a non-volatile memory such as a flash memory, a hard disk, a removable disk, or any type of computer-readable recording medium well known in the art to which the present disclosure pertains. In some embodiments, storage 1300 may include a secure element that allows access of only some applets.

The computer program 1500 may include one or more instructions, in which methods/operations according to various embodiments of the present disclosure are implemented. When the computer program 1500 is loaded into the memory 1400, the processor 1100 may execute the one or more instructions to perform methods/operations according to various embodiments of the present disclosure.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for managing an application in a short-range communication device, the method comprising:
receiving application installation request information from an administrator of the short-range communication device;
generating authentication information for installing the application by using the received application installation request information;
requesting a first server to verify the authentication information;
downloading application installation data based on a verification of the authentication information; and
installing the application in an application platform region of the short-range communication device using the application installation data, and installing an applet for interworking with the application in a secure element of the short-range communication device.

2. The method of claim 1, wherein the installing the applet for interworking with the application, in the secure element comprises:
installing the applet for interworking with the application, in the secure element by an agent executing in the short-range communication device; and
establishing by the agent, a service configuration relationship between the applet for interworking with the application, and the application.

3. The method of claim 2, wherein the installing the applet for interworking with the application, in the secure element further comprises:
obtaining by the agent, installation data of the applet for interworking with the application, from a second server by the agent;
requesting by the agent, a system applet installed in the secure element to install the applet for interworking with the application; and
installing by the system applet, the applet for interworking with the application, in the secure element using the installation data of the applet for interworking with the application.

4. The method of claim 1, wherein the application installation request information comprises identification information of a provisioning authority and a one-time password issued by the provisioning authority,
wherein the generating the authentication information comprises:
obtaining a pair of a first public key and a first private key of the short-range communication device;
obtaining a second public key corresponding to the identification information of the provisioning authority; and
generating the authentication information including the one-time password encrypted based on the first private key and the second public key.

5. The method of claim 4, wherein obtaining the second public key comprises:
transferring the identification information of the provisioning authority and the first private key to a system applet executing in the secure element by an agent executing in the short-range communication device; and
obtaining the second public key corresponding to the identification information of the provisioning authority from the secure element by the system applet.

6. The method of claim 5, wherein generating the authentication information comprises:
generating a security key using the obtained second public key and the first private key, and encrypting the one-time password using the generated security key by the system applet.

7. The method of claim 4, wherein requesting the first server to verify the authentication information comprises:
transmitting the encrypted one-time password and the first public key to the first server,
wherein the first server decrypts and verifies the encrypted one-time password based on the first public key and the private key of the provisioning authority.

8. The method of claim 4 further comprises:
before receiving the application installation request information from the administrator,
obtaining a provisioning authority list comprising identification information of one or more provisioning authorities and a public key from a second server in response to a system update request; and
storing the provisioning authority list in the secure element.

9. The method of claim 8 further comprises:
obtaining the provisioning authority list stored in the secure element; and
verifying whether identification information of the provisioning authority included in the application installation request information is included in the provisioning authority list,
wherein the authentication information is generated based on the identification information of the provisioning authority being included in the provisioning authority list.

10. The method of claim 1, wherein receiving the application installation request information from the administrator comprises:
accessing an app store to obtain an application list dedicated to the short-range communication device; and
receiving selection information for the application from the application list.

11. The method of claim 1 further comprises:
receiving deletion request information of the application from the administrator;
generating deletion authentication information of the application and requesting the first server to verify the deletion authentication information; and
deleting the application from the application platform region in response to a verification of the deletion authentication information.

12. The method of claim 11, wherein deleting the application from the application platform region comprises:
removing a service configuration relationship between the applet for interworking with the application, installed in the secure element and the application installed in the application platform region; and
removing the applet for interworking with the application, installed in the secure element.

13. A method for managing an application in a short-range communication device, the method comprising:
receiving application installation request information including authentication information from an administrator of the short-range communication device;
forming a session with a first server for installing the application and generating a session key;
encrypting the authentication information using the session key;
requesting the first server to verify the encrypted authentication information;
receiving application installation data from the first server based on a verification of the authentication information; and
installing the application in an application platform region of the short-range communication device using the application installation data.

14. The method of claim 13, wherein installing the application in the application platform region of the short-range communication device comprises:
installing an applet for interworking with the application in a secure element of the short-range communication device by an agent executing in the short-range communication device; and
establishing a service configuration relationship between the applet for interworking with the application and the application by the agent.

15. The method of claim 13, wherein the authentication information is a token issued by a provisioning authority,
wherein encrypting the authentication information comprises encrypting the token using the session key,
wherein the first server decrypts the encrypted token using the session key to verify the token, and transmits the application installation data to the short-range communication device based on the token being verified.

16. The method of claim 13, wherein receiving the application installation data from the first server comprises:
receiving at least one of a hash or an electronic signature of the application installation data from the first server,
wherein the installing the application in an application platform region of the short-range communication device comprises:
performing at least one of a hash verification of the application installation data and a verification of the electronic signature; and
installing an application into an application platform region in response to one or more of the hash verification or the electronic signature being verified.

17. A computing device comprising:
one or more processors;
a memory for loading a computer program executed by the processor; and
a storage for storing the computer program;
wherein the computer program comprises instructions for performing operations comprising:
receiving application installation request information from an administrator;
generating authentication information for installing the application using the received application installation request information;
requesting a first server to verify the authentication information;
downloading application installation data based on a verification of the authentication information; and
installing the application in an application platform region of the short-range communication device using the application installation data, and installing an applet for interworking with the application in a secure element of the short-range communication device.
